(19) United States
(12) Patent Application Publication
(10) Pub. No.: US 2019/0131019 A1
(43) Pub. Date: May 2, 2019

(54) ORTHOGONAL APPROACH TO INTEGRATE INDEPENDENT OMIC DATA

(71) Applicant: WAYNE STATE UNIVERSITY, Detroit, MI (US)

(72) Inventors: Sorin DRAGHICI, Detroit, MI (US); Tin Chi NGUYEN, Detroit, MI (US)

(73) Assignee: WAYNE STATE UNIVERSITY, Detroit, MI (US)

(21) Appl. No.: 16/099,975

(22) PCT Filed: May 9, 2017
(86) PCT No.: PCT/US2017/031799

§ 371 Date: Nov. 8, 2018

Related U.S. Application Data
(60) Provisional application No. 62/333,407, filed on May 9, 2016.

(51) Int. Cl. G16Z 99/00

(52) U.S. Cl. CPC G16Z 99/00

(57) ABSTRACT

Methods and devices for integrating a plurality of data types are provided. The methods include obtaining, via a processor, a plurality of datasets of a given type including measurements of one or more quantitative variables related to a phenotype comparison, and a plurality of datasets of a different type including measurements of one or more quantitative variables related to the same phenotype comparison; calculating, via the processor, effect sizes of the variables of the first type, effect sizes of the variables of the second type, and global p-values for the first and second data types; and combining, via the processor, the effect sizes and/or the global p-values to identify the variables of either type that are relevant in the given phenotype comparison.

### CROSS-REFERENCE TO RELATED APPLICATIONS

This application claims the benefit of U.S. Provisional Application No. 62/333,407, filed on May 9, 2016. The entire disclosure of the above application is incorporated herein by reference.

### GOVERNMENT RIGHTS

This invention was made with U.S. Government support under NIH RO1 DK089167, R42 GM087013 and NSF DBI-0965741. The Government has certain rights in the invention.

### FIELD

The present disclosure relates to two-dimensional data integration that combines data obtained from many independent experiments.

### BACKGROUND

This section provides background information related to the present disclosure which is not necessarily prior art.

High-throughput technologies for gene expression profiling, such as DNA microarray or RNA-Seq, have transformed biomedical research by allowing for comprehensive monitoring of biological processes. A typical comparative analysis of expression data, e.g., patients (“unhealthy condition,” i.e., disease) versus control samples (“healthy condition”), generally yields a set of genes that are differentially expressed (DE) between the conditions. These sets of DE genes contain the genes that are likely to be involved in the biological processes responsible for the disease. However, such sets of genes are often insufficient to reveal the underlying biological mechanisms. In addition, due to inherent bias and batch effects present in individual studies, independent experiments studying the same disease often yield completely different lists of DE genes, making interpretation extremely difficult.

In order to translate these lists of DE genes into a better understanding of biological phenomena, a variety of knowledge bases have been developed that map genes to functional modules. Depending on the amount of information that one wishes to include, these modules can be described as simple gene sets based on a function, process or component (e.g., the Molecular Signatures Database MSigDB), organized in a hierarchical structure that contains information about the relationship between the various modules or organized into pathways that describe in detail all known interactions between various genes that are involved in a certain phenomenon. Exemplary pathway databases include: the Kyoto Encyclopedia of Genes and Genomes (KEGG), Reactome, and Biocarta.

Analysis techniques have been developed to help interpret such sets of DE genes. The earliest approaches use Over-Representation Analysis (ORA) to identify gene sets that have more DE genes than expected by chance. The drawbacks of this type of approach include that: (i) it only considers the number of DE genes and completely ignores expression changes; (ii) it assumes that genes are independent, which they are not; and (iii) it ignores the interactions between various modules. Functional Class Scoring (FCS) approaches, such as Gene Set Enrichment Analysis (GSEA) and Gene Set Analysis (GSA), have been developed to address some of the issues raised by ORA approaches. The main improvement of FCS is the observation that small but coordinated changes in expression of functionally related genes can have significant impacts on pathways. Both FCS and ORA approaches can be used with gene sets, ontologies, or pathways. However, these approaches do not account for the hierarchical structure of pathways or interactions between genes. Topology-based approaches, which fully exploit all the knowledge about how genes interact as described by pathways, have been developed more recently. The first such techniques were ScorePAGE for metabolic pathways and the Impact Analysis for signaling pathways.

Non-coding RNAs, especially microRNAs (miRNAs) have come into the spotlight more recently. Data describing observed and predicted interactions between miRNA and mRNA is accumulating rapidly in several databases, such as, for example, miRTarBase, miRWalk, starBase, and TargetScan. In addition, miRNA expression platforms, datasets and analysis tools have become more and more prevalent.

Two of the most widely used approaches to include miRNA expression data for the purpose of pathway analysis are Micrographite and PARADIGM. Micrographite is a topology-aware pathway analysis approach that is able to integrate sample-matched miRNA and mRNA expression. PARADIGM uses a probabilistic graphical model (PGM) to integrate information of different data types, which may include mRNA and miRNA.

One drawback of these tools for integrating miRNA and mRNA is that they need sample-matched data. In other words, these tools require both data types to be available for each individual patient. This requirement reduces their practical availability because sample-matched data is relatively rare and difficult or expensive to obtain. Therefore, the vast amount of available expression data, both mRNA and mi RNA, is not fully utilized.

Another drawback is that these methods are unable to exploit heterogeneous information available across independent studies. Therefore, they are not able to address the inevitable bias inherent in individual studies. It would be tremendously beneficial if all datasets associated with a given condition could be analyzed together because of the increased power expected to be associated with the much larger number of measurements in the combined dataset. Large public repositories such as Gene Expression Omnibus, The Cancer Genome Atlas (cancergenome.nih.gov), ArrayExpress, and Therapeutically Applicable Research to Generate Effective Treatments (ocg.cancer.gov/programs/target) store thousands of datasets, within which there are independent experimental series with similar patient cohorts and experiment design. Expression data, mRNA as well as miRNA, are particularly prevalent in public databases, such that some disease conditions are represented by half a dozen studies or more.

The process of combining sample-matched data of different types is referred to as “vertical” integrative analysis, while that of combining multiple unmatched studies using the same data type is referred as “horizontal” meta-analysis. Thus, the vertical and horizontal analyses are considered “orthogonal” classes of data integration. For microarray data, one of the earliest horizontal approaches for combining multiple microarray datasets included the use of Fisher's method. Since then, other sophisticated approaches have been proposed for the integration of multiple gene expression datasets, on both gene and pathway levels. The majority of these meta-analysis approaches work by combining p-values obtained from individual gene expression datasets. However, the approaches typically do not try to account for data heterogeneity, attributed to batch effects, patient heterogeneity, and disease complexity, responsible for expression changes across different sources. Accordingly, there remains a need for a framework that is able to integrate unmatched miRNA and mRNA data obtained from many independent laboratories.

### SUMMARY

This section provides a general summary of the disclosure, and is not a comprehensive disclosure of its full scope or all of its features.

The current technology provides a method of integrating a plurality of data types. The method includes obtaining, via a processor, a plurality of datasets of a given type including measurements of one or more quantitative variables related to a phenotype comparison, and a plurality of datasets of a different type including measurements of one or more quantitative variables related to the same phenotype comparison; calculating, via the processor, a first standardized mean difference (SMD), a first standard error, and a first p-value for each of the variables and for each dataset present in the plurality of datasets of the first type; calculating, via the processor, a second SMD, a second standard error, and a second p-value for each of the variables and for each data set present in the plurality of datasets of the second type; combining, via the processor, all the effect sizes in each individual dataset to calculate an effect size for each of the variables of the first data type, from the first SMD and the first standard error; combining, via the processor, all p-values in each individual dataset to calculate a global p-value for this first data type; combining, via the processor, all the effect sizes in each individual dataset to calculate an effect size for each of the variables of the second data type, from the second SMD and the second standard error; combining, via the processor, all p-values in each individual dataset to calculate a global p-value for the second data type; and combining, via the processor, the effect sizes of the variables of the first type with the effect sizes of the variables of the second type and/or combining the p-values of the variables of the first type with the p-values of the variables of the second type to identify the variables of either type that are relevant in the given phenotype comparison.

In various embodiments, there are more than two data types.

The current technology also provides a method of identifying a pathway associated with a disease. The method includes obtaining, via a processor, a plurality of first datasets describing a first quantitative variable related to the disease and a plurality of second datasets describing a second quantitative variable related to the disease, the plurality of first datasets and the plurality of second datasets being provided from independent studies, wherein each of the plurality of first datasets and each of the plurality of second datasets includes data regarding disease samples and healthy control samples; modifying, via the processor, known pathways related to the disease with information provided in both the plurality of first datasets and the plurality of second datasets to generate augmented pathways including a plurality of first nodes associated with the first quantitative variable and a plurality of second nodes associated with the second quantitative variable, wherein the first nodes and second nodes are individually interconnected; calculating, via the processor, a first standardized mean difference (SMD), a first standard error, and a first p-value for each of the plurality of first datasets; calculating, via the processor, a second SMD, a second standard error, and a second p-value for each of the plurality of second datasets; estimating, via the processor, a first effect size from the first SMD and the first standard error; combining, via the processor, the first p-values; estimating, via the processor, a second effect size from the second SMD and the second standard error; combining, via the processor, the second p-values; calculating, via the processor, a probability of obtaining at least an observed relationship between the first and second quantitative variables associated with the disease (P_{NDE}) and a p-value that depends on identities of first or second quantitative variables that are differentially related and described by the pathway (P_{PERT}) from the augmented pathways, the estimated first effect size, the combined first p-values, the estimated second effect size, and the combined second p-values; and combining, via the processor, P_{NDE} and P_{PERT} to generate a single p-value that represents how likely a pathway is impacted under the effect of the disease.

In various embodiments, the estimating a first effect size and the estimating a second effect size are performed by using a Restricted Maximum Likelihood (REML) algorithm.

In various embodiments, the combining the first p-values and the combining the second p-values is performed by add-CLT.

In various embodiments, the first quantitative variable and the second quantitative variable individually include one of molecular data and clinical data.

In various embodiments, the molecular data describes assay results related to at least one of mRNA, miRNA, protein abundance, metabolite abundance, and methylation; and the clinical data describes patient information related to at least one of weight, blood pressure, blood metabolite level, blood sugar, heart rate, vision score, and hearing score.

In various embodiments, the method further includes generating a plurality of single p-values corresponding to a plurality of pathways and generating a graphical representation of the pathways ranked according to their corresponding single p-values.

The current technology also provides an apparatus for identifying a pathway associated with a disease. The apparatus includes a memory configured to store one or more applications; a processor communicatively coupled to memory, the processor, upon executing the one or more applications, is configured to: obtain a plurality of first datasets describing a first quantitative variable related to the disease and a plurality of second datasets describing a second quantitative variable related to the disease, the plurality of first datasets and the plurality of second datasets being provided from independent studies, wherein each of the plurality of first datasets and each of the plurality of second datasets includes data regarding disease samples and healthy control samples; modify known pathways related to the disease with information provided in both the plurality of first datasets and the plurality of second datasets to generate augmented pathways including a plurality of first nodes associated with the first quantitative variable and a plurality of second nodes associated with the second quantitative variable, wherein the first nodes and second nodes are individually interconnected; calculate a first standardized mean difference (SMD), a first standard error, and a first p-value for each of the plurality of first datasets; calculate a second SMD, a second standard error, and a second p-value for each of the plurality of second datasets; estimate a first effect size from the first SMD and the first standard error; combine the first p-values; estimate a second effect size from the second SMD and the second standard error combine the second p-values; calculate a probability of obtaining at least an observed relationship between the first and second quantitative variables associated with the disease (P_{NDE}) and a p-value that depends on identities of first or second quantitative variables that are differentially related and described by the pathway (P_{PERT}) from the augmented pathways, the estimated first effect size, the combined first p-values, the estimated second effect size, and the combined second p-values; and combine P_{NDE} and P_{PERT} to generate a single p-value that represents how likely a pathway is impacted under the effect of the disease.

In various embodiments the processor is configured to estimate a first effect size and estimate a second effect size using a Restricted Maximum Likelihood (REML) algorithm.

In various embodiments the processor is configured to combine the first p-values and to combine the second p-values by add-CLT.

In various embodiments the first quantitative variable and the second quantitative variable individually include one of molecular data and clinical data.

In various embodiments the molecular data describes assay results related to at least one of mRNA, miRNA, protein abundance, metabolite abundance, and methylation; and the clinical data describes patient information related to at least one of weight, blood pressure, blood metabolite level, blood sugar, heart rate, vision score, and hearing score.

In various embodiments the processor is configured to generate a plurality of single p-values corresponding to a plurality of pathways and generate a graphical representation of the pathways ranked according to their corresponding single p-values.

In various embodiments, the processor is further configured to cause the graphical representation to be displayed at a display.

Additionally, the current technology provides a distributed computing system for identifying a pathway associated with a disease. The distributed computing system includes a first server configured to store a plurality of first datasets; a second server configured to store a plurality of second datasets, the second server different from the first server; a third server communicatively coupled to the first server and the second server via a distributed communication network, the third server including: a memory configured to store one or more applications; processor communicatively coupled to the memory, the processor, upon executing the one or more applications, is configured to: obtain the plurality of first datasets describing a first quantitative variable related to the disease and the plurality of second datasets describing a second quantitative variable related to the disease, the plurality of first datasets and the plurality of second datasets being provided from independent studies, wherein each of the plurality of first datasets and each of the plurality of second datasets includes data regarding disease samples and healthy control samples; modify known pathways related to the disease with information provided in both the plurality of first datasets and the plurality of second datasets to generate augmented pathways including a plurality of first nodes associated with the first quantitative variable and a plurality of second nodes associated with the second quantitative variable, wherein the first nodes and second nodes are individually interconnected; calculate a first standardized mean difference (SMD), a first standard error, and a first p-value for each of the plurality of first datasets; calculate a second SMD, a second standard error, and a second p-value for each of the plurality of second datasets; estimate a first effect size from the first SMD and the first standard error; combine the first p-values; estimate a second effect size from the second SMD and the second standard error; combine the second p-values; calculate a probability of obtaining at least an observed relationship between the first and second quantitative variables associated with the disease (P_{NDE}) and a p-value that depends on identities of first or second quantitative variables that are differentially related and described by the pathway (P_{PERT}) from the augmented pathways, the estimated first effect size, the combined first p-values, the estimated second effect size, and the combined second p-values; and combine P_{NDE} and P_{PERT} to generate a single p-value that represents how likely a pathway is impacted under the effect of the disease.

In various embodiments, the processor is configured to estimate a first effect size and estimate a second effect size using a Restricted Maximum Likelihood (REML) algorithm.

In various embodiments, the processor is configured to combine the first p-values and to combine the second p-values by add-CLT.

In various embodiments, the first quantitative variable and the second quantitative variable individually include one of molecular data and clinical data.

In various embodiments, the molecular data describes assay results related to at least one of mRNA, miRNA, protein abundance, metabolite abundance, and methylation; and the clinical data describes patient information related to at least one of weight, blood pressure, blood metabolite level, blood sugar, heart rate, vision score, and hearing score.

In various embodiments, the processor is configured to generate a plurality of single p-values corresponding to a plurality of pathways and generate a graphical representation of the pathways ranked according to their corresponding single p-values.

In various embodiments, the distributed computing system further includes a display, wherein the processor is further configured to cause display of the graphical representation at the display.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a simplified block diagram of an example distributed computing system.

FIG. 2 is a functional block diagram of an example implementation of a client device.

FIG. 3 is a functional block diagram of an example implementation of a server.

FIG. 4 is a functional block diagram of an example database in accordance with an example implementation of the present disclosure.

FIG. 5 shows a graphical representation of a framework according to various aspects of the current technology. The input includes: (i) a pathway database and a miRNA database including known targets (panel a), (ii) multiple mRNA expression datasets (panel b), and (iii) multiple miRNA expression datasets (panel c). Each expression dataset includes two groups of samples, e.g., disease versus control. The framework first augments the signaling pathways with miRNA molecules and their interactions with coding mRNA genes (panel d). It then calculates the standardized mean difference and its standard error in each expression dataset. The summary size effect across multiple datasets for each data type are then estimated using the REstricted Maximum Likelihood (REML) algorithm (panels e,f). Similarly, the p-value for differential expression is calculated for each dataset and then combined using the additive method (add-CLT). The augmented pathways, the combined p-values, and the estimated size effects then serve as input for ImpactAnalysis, which is a topology-aware pathway analysis method (panel g).

FIG. 6 shows a graphical representation of an augmented pathway regarding colorectal cancer. The green rectangle nodes (light shaded rectangles) and black arrows show the KEGG genes and their interactions while the blue nodes (dark shaded rectangles) and bar-headed lines show the miRNAs and their interactions with the genes, respectively. In each miRNA node added, the total number of miRNAs (circles) that are known to target the gene, and the names of the miRNA (blue (dark shaded) rectangles) that were actually measured in the 8 colorectal miRNA datasets, are shown. This is a subset of the total set of miRNAs known to target genes on this pathway.

FIG. 7 shows a graphical representation of an augmented pathway regarding pancreatic cancer. The green rectangle nodes (dark shaded rectangles) and black arrows show the KEGG genes and their interactions while the blue nodes (dark shaded rectangles) and bar-headed lines show the miRNAs and their interactions with the genes. In each miRNA node added, the total number of miRNAs (circles) that are known to target the gene, and the names of the miRNA (blue (dark shaded) rectangles) that were actually measured in the 6 pancreatic miRNA datasets, are shown. This is a subset of the total set of miRNAs known to target genes on this pathway.

FIG. 8 is a flow chart illustrating an example method for identifying a pathway associated with a disease in accordance with an example embodiment of the present disclosure.

Corresponding reference numerals indicate corresponding parts throughout the several views of the drawings.

### DETAILED DESCRIPTION

Example embodiments will now be described more fully with reference to the accompanying drawings.

The current technology provides a framework that is able to integrate unmatched miRNA and mRNA data obtained from many independent laboratories. While validated in the context of pathway analysis, the framework can be modified to adapt to other domains or applications. This framework is not meant to compete with any existing approach, but to serve as a bridge between “horizontal” and “vertical” data integration. Each building block or technique of the framework can be easily substituted for by any other similar technique to suit the purpose of future analysis.

The framework is illustrated using 15 mRNA and 14 miRNA datasets related to two human diseases (also referred to as “conditions”), colorectal cancer and pancreatic cancer. The datasets were generated by independent labs, for different sets of patients. For both conditions, the framework is able to identify pathways relevant to the phenotypes. Accuracy is obtained only by integrating the data in both directions (horizontal and vertical). However, it is understood that the framework can be applied to other diseases, conditions, or characteristics as well.

The framework provides an orthogonal meta-analysis. Orthogonal classes of integrative techniques can be further combined to unravel underlying mechanisms of complex diseases. With vast databases of various data types being made available, this framework is widely applicable because of its relaxed restrictions on the data being integrated.

Below are simplistic examples of a distributed computing environment in which the systems and methods of the present disclosure can be implemented. Throughout the description, references to terms such as servers, client devices, applications and so on are for illustrative purposes only. The terms server and client device are to be understood broadly as representing computing devices with one or more processors and memory configured to execute machine readable instructions. The terms application and computer program are to be understood broadly as representing machine readable instructions executable by the computing devices.

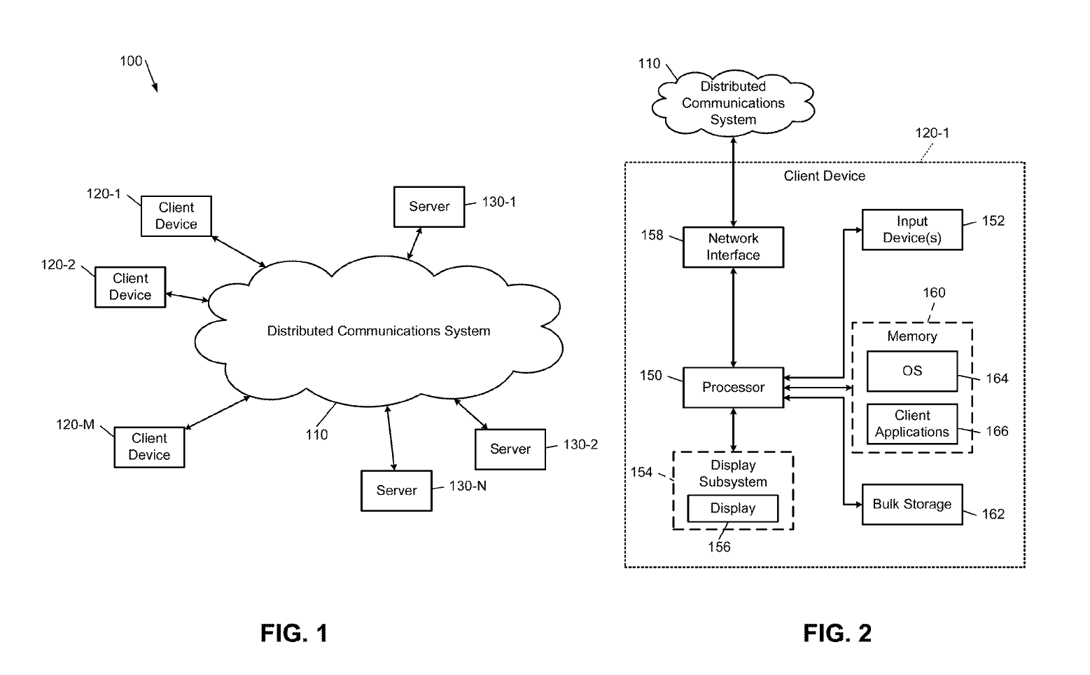

FIG. 1 shows a simplified example of an example computing system 100. The computing system 100 includes a distributed communications system 110, one or more client devices 120-1, 120-2, . . . , and 120-M (collectively, client devices 120), and one or more servers 130-1, 130-2, . . . , and 130-M (collectively, servers 130). N and M are integers greater than or equal to one. The distributed communications system 110 may include a local area network (LAN), a wide area network (WAN) such as the Internet, or other type of network. For example, the servers 130 may be located at different geographical locations. The client devices 120 and the servers 130 communicate with each other via the distributed communications system 110. The client devices 120 and the servers 130 connect to the distributed communications system 110 using wireless and/or wired connections.

The client devices 120 may include smartphones, personal digital assistants (PDAs), laptop computers, personal computers (PCs), etc. The servers 130 may provide multiple services to the client devices 120. For example, the servers 130 may execute software applications developed by one or more vendors. The server 130 may host multiple databases that are relied on by the software applications in providing services to users of the client devices 120.

FIG. 2 shows a simplified example of the client device 120-1. The client device 120-1 may typically include a central processing unit (CPU) or processor 150, one or more input devices 152 (e.g., a keypad, touchpad, mouse, touchscreen, etc.), a display subsystem 154 including a display 156, a network interface 158, memory 160, and bulk storage 162.

The network interface 158 connects the client device 120-1 to the distributed computing system 100 via the distributed communications system 110. For example, the network interface 158 may include a wired interface (for example, an Ethernet interface) and/or a wireless interface (for example, a Wi-Fi, Bluetooth, near field communication (NFC), or other wireless interface). The memory 160 may include volatile or nonvolatile memory, cache, or other type of memory. The bulk storage 162 may include flash memory, a magnetic hard disk drive (HDD), and other bulk storage devices.

The processor 150 of the client device 120-1 executes an operating system (OS) 164 and one or more client applications 166. The client applications 166 include an application that accesses the servers 130 via the distributed communications system 110.

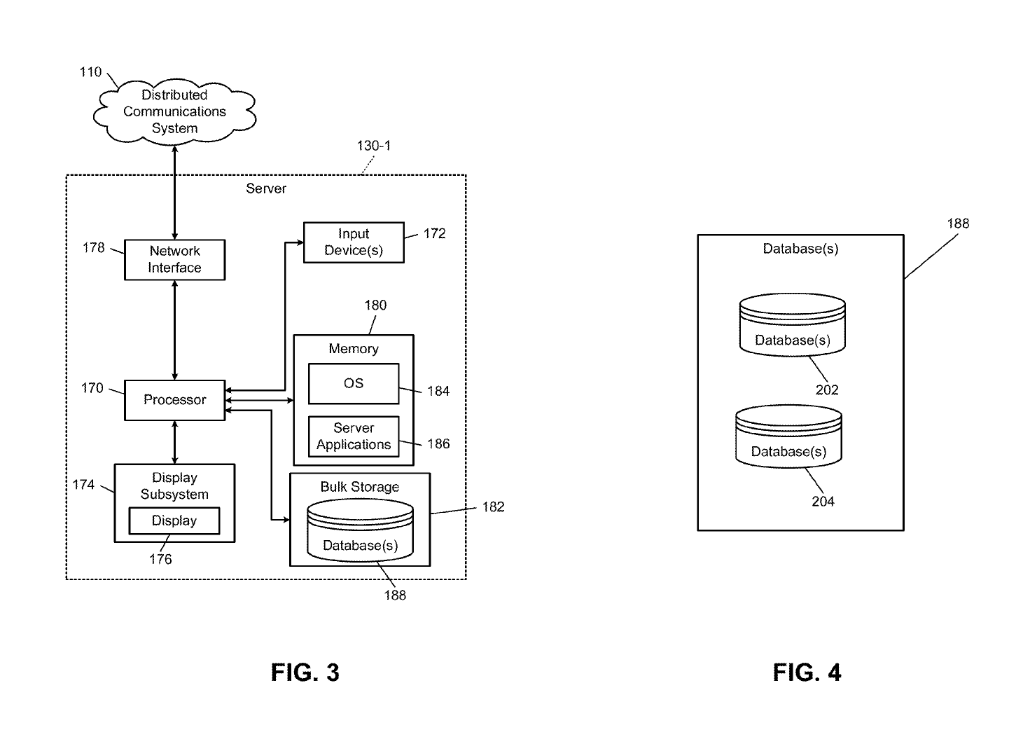

FIG. 3 shows a simplified example of the server 130-1. The server 130-1 typically includes one or more CPUs or processors 170, a network interface 178, memory 180, and bulk storage 182. In some implementations, the server 130-1 may be a general-purpose server and include one or more input devices 172 (e.g., a keypad, touchpad, mouse, and so on) and a display subsystem 174 including a display 176.

The network interface 178 connects the server 130-1 to the distributed communications system 110. For example, the network interface 178 may include a wired interface (e.g., an Ethernet interface) and/or a wireless interface (e.g., a Wi-Fi, Bluetooth, near field communication (NFC), or other wireless interface). The memory 180 may include volatile or nonvolatile memory, cache, or other type of memory. The bulk storage 182 may include flash memory, one or more magnetic hard disk drives (HDDs), or other bulk storage devices.

The processor 170 of the server 130-1 executes an operating system (OS) 184 and one or more server applications 186, which may be housed in a virtual machine hypervisor or containerized architecture. The bulk storage 182 may store one or more databases 188 that store data structures used by the server applications 186 to perform respective functions.

As shown in FIG. 4, the databases 188 store various data structures for storing multiple datasets. For example, a first database 202 may store a first dataset that describes a first quantitative variable related to the disease. A second database 204 may store a second dataset that describes a second quantitative variable related to the disease. While FIG. 4 illustrates a first database 202 and a second database 204, the distributed computing system 100 can include any number of databases without departing from the spirit of the disclosure. The databases 202, 204 store quantitative variables that can include molecular data and/or clinical data. For example, the molecular data can include assay results related to at least one of mRNA, miRNA, protein abundance, metabolite abundance, and methylation. The clinical data can include patient information related to at least one of weight, blood pressure, blood metabolite level, blood sugar, heart rate, vision score, and hearing scores. It is understood that the databases 202, 204 includes a plurality of datasets of a given type that include measurements of one or more quantitative variables related to a phenotype comparison. Additionally, the databases 202, 204 include a plurality of datasets of a different type that measurements of one or more quantitative variables related to the same phenotype comparison. The datasets can represent data pertaining to financial, health, business, social, geography, geology, and the like.

The server 130-1 receives and stores data to the corresponding data structures. The data can be received from the client devices 120-1 through 120-M and/or servers 130-2 through 130-N. The data can be provided by or obtained from disparate entities. In an example embodiment, the computing system 100 employs an edge computing architecture, a fog computing architecture, a centralized computing architecture, and the like. Thus, due to the quantity of data within the respective datasets 202, 204, data can be stored in databases 188 proximate to the server 130-1 allowing for resource pooling, latency reduction, and increased processing power.

As described herein, the processor 170 executes the one or more server applications 186 to perform the functionality described herein. For example, in one or more embodiments, the processor 170 accesses data within the various data structures to perform the functionality described herein.

### Summary

MicroRNAs (miRNAs) are small non-coding RNA molecules whose primary function is to regulate the expression of gene products via hybridization to mRNA transcripts, resulting in suppression of translation or mRNA degradation. Although miRNAs have been implicated in complex diseases, including cancer, their impact on distinct biological pathways and phenotypes is largely unknown. Current integration approaches require sample-matched miRNA/mRNA datasets, resulting in limited applicability in practice. Because these approaches cannot integrate heterogeneous information available across independent experiments, they neither account for bias inherent in individual studies, nor do they benefit from increased sample size. The current technology provides a novel framework able to integrate miRNA and mRNA data (vertical data integration) available in independent studies (horizontal meta-analysis) allowing for a comprehensive analysis of the given phenotypes. To demonstrate the utility of the framework, a meta-analysis of pancreatic and colorectal cancer, using 1,471 samples from 15 mRNA and 14 miRNA expression datasets, is conducted. The current two-dimensional data integration approach greatly increases the power of statistical analysis relative to conventional approaches and correctly identifies pathways known to be implicated in the phenotypes. The framework is general and can be used to integrate other types of data obtained from high-throughput assays.

### Methods

The classical pathway analysis begins by considering a comparison between two conditions, e.g., disease versus healthy. Evidence for differential gene expression can be provided by any technique such as fold change, t-statistic, Kolmogorov-Smirnov statistic, or perturbation factor. These statistics are then compared against a null distribution to determine how unlikely it is for the observed differences between the two conditions to occur by chance, thereby producing a ranked list of DE genes. After this hypothesis testing is done at the gene level, the next step is hypothesis testing at the pathway level producing a ranked list of impacted pathways. In summary, the input of a classical pathway analysis method includes: (i) a pathway database, and (ii) a gene expression dataset. The output is a list of pathways ranked according to their p-values.

Similarly, the input of the new approach includes: (i) a pathway database, (ii) a database of miRNA-mRNA interactions, (iii) multiple gene expression datasets, and (iv) multiple miRNA expression datasets. Each dataset is obtained from an independent study of the same disease. A framework that transforms the new problem into the classical pathway analysis problem is now provided.

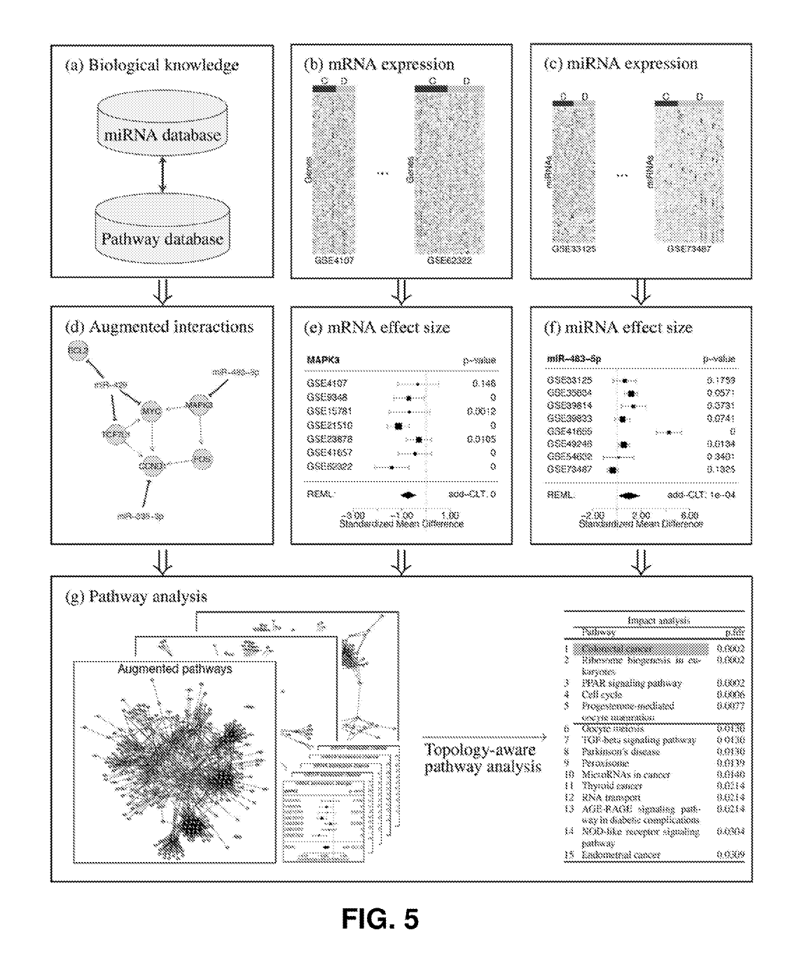

FIG. 5 illustrates a pipeline of the framework for the case of colorectal cancer. Panel (a) represents biological knowledge obtained from databases: pathway information (i.e., database 204) and miRNA targets (i.e., database 202). Panel (b) shows a set of gene expression datasets obtained from independent studies coming from different laboratories. Seven datasets (GSE4107, GSE9348, GSE15781, GSE21510, GSE23878, GSE41657, and GSE62322), related to the same disease, colorectal cancer, are used for this example. Each dataset has two groups of samples: disease (group D) and control/healthy (group C). Panel (c) represents a set of miRNA expression datasets (GSE33125, GSE35834, GSE39814, GSE39833, GSE41655, GSE49246, GSE54632, and GSE73487), also from colorectal cancer. Similar to gene expression datasets, each miRNA dataset consists of disease and control samples. The data provided in panels (a,b,c) serve as input for the framework.

Pathways in databases are typically described as graphs, where nodes are genes and edges are interactions between genes. In a first step, existing pathways are extended with additional interactions between miRNAs and mRNAs. Panel (d) shows a part of the pathway Colorectal cancer, where blue (circular) nodes are genes and red nodes (beginning with “mi”) are miRNAs. Arrow-headed lines represent activation while bar-headed lines represent inhibition. For example, hsa-miR-483-5p is known to suppress the expression of MAPK3 and therefore an inhibition relationship is added between the two nodes in the pathway. All pathways are extended to include the known miRNA-mRNA interactions. Estimating expression changes of each node (gene, miRNA) under the effects of the disease is then performed.

Panel (e) shows expression changes and p-values for one gene in the mRNA data, across several datasets. Here, the MAPK3 gene is used as an example. In the forest plot shown in this panel, each horizontal line represents the expression change in each study. The small black box in each line shows a standardized mean difference (SMD) and the segment shows the confidence interval of SMD. Standardized mean difference is used instead of raw difference because the independent studies measure the expression in a variety of ways (different platforms, sample preparation, etc.). The number on the right side of each line is the p-value of the test for differential expression, using the modified t-test provided in the limma package.

As shown in FIG. 5, the SMD and p-value of a gene vary from study to study. REstricted Maximum Likelihood (REML) algorithm is used to estimate the central tendency of SMD. The add-CLT method is used to combine the independent p-values. Likewise, estimated SMDs and p-values for miRNA datasets (panel f) are computed.

The augmented pathways, the combined p-value, together with the estimated size effect then serve as input for classical pathway analysis. Here, Impact Analysis, which is a topology-aware pathway analysis method, is used to calculate a p-value for each augmented pathway (panel g).

Standardized Mean Difference for Each Gene

As an example, a study composed of two independent groups is considered, and it is desired to compare their means for a given gene. Here, x̅₁̅ and x̅₂̅ represent the sample means for that gene in the two groups, n₁ and n₂ the number of samples in each group, and S_{pooled} the pooled standard deviation of the two groups. The pooled standard deviation and the standardized mean difference (SMD) can be estimated as follows.

$$\begin{matrix}{S}_{pooled} = \sqrt{\frac{( {n}_{1} - 1 ) {S}_{1}^{2} + ( {n}_{2} - 1 ) {S}_{2}^{2}}{{n}_{1} + {n}_{2} - 2}} & ( 1 ) \\ d = \frac{{\overline{X}}_{1} - {\overline{X}}_{2}}{{S}_{pooled}} & ( 2 )\end{matrix}$$

The estimation of the standardized mean difference described in Equation (2) may be called Cohen's d. The variance of Cohen's d is given as follows.

$${V}_{d} = \frac{{n}_{1} + {n}_{2}}{{n}_{1} {n}_{2}} + \frac{{d}^{2}}{2 ( {n}_{1} + {n}_{2} )} \qquad ( 3 )$$

In the above equation, the first term reflects uncertainty in the estimate of the mean difference, and the second term reflects uncertainty in the estimate of S_{pooled}. The standard error of d is the square root of V_{d}. Cohen's d, which is based on sample averages, tends to overestimate the population effect size for small samples. n represents the degrees of freedom used to estimate S_{pooled}, i.e., n=n₁+n₂−2. The corrected effect size, or Hedges' g, is computed as follows:

$$\begin{matrix}J = \frac{Γ ( \frac{n}{2} )}{\sqrt{\frac{n}{2}} Γ ( \frac{n - 1}{2} )} & ( 4 ) \\ g = J \cdot d & ( 5 )\end{matrix}$$

where Γ is a gamma function. Here, Hedge' g is used as the standardized mean difference (SMD) between disease and control groups for each gene/miRNA.

Random-Effects Model and REML

A collection of m studies is considered, where the effect size estimates, y₁, . . . , yₘ have been derived from a set of studies, each of them modeled as in Equation (5). A fixed-effects model would assume that there is one true effect size which underlies all of the studies in the analysis, such that all differences in observed effects are due to sampling error. However, this assumption is implausible because it cannot account for heterogeneity between studies.

In contrast, the random-effects model allows for variability of the true effect. For example, the effect size might be higher (or lower) in studies where the participants are older, or have a healthier lifestyle compared to others. The random-effects model assumes that each effect size estimate can be decomposed into two variance components by a two-stage hierarchical process. The first variance represents variability of the effect size across studies, and the second variance represents sampling error within each study. The random-effects model may be:

yᵢ=μ+N(0,σ²)+N(0,σ_{εi}²) (6),

where μ is the central tendency of the effect size, N(0,σ²) represents the error term by which the effect size in the i^{th} study differs from the central tendency μ, and N(0,σ_{εi}²) represents the sampling error.

The derivation and formulation of the REstricted Maximum Likelihood (REML) algorithm is known in the art. The log-likelihood function for Equation (6) is given by Equation (7).

$$l ( μ , {σ}^{2} ; y ) = - \frac{1}{2} {\sum }_{i = 1}^{m} ln ( {σ}^{2} + {σ}_{{ɛ}_{i}}^{2} ) - \frac{1}{2} ln {\sum }_{i = 1}^{m} \frac{1}{{σ}^{2} + {σ}_{{ɛ}_{i}}^{2}} - \frac{1}{2} {\sum }_{i = 1}^{m} \frac{{( {y}_{i} - μ )}^{2}}{{σ}^{2} + {σ}_{{ɛ}_{i}}^{2}} \qquad ( 7 )$$

The REML estimators of \hat{μ} and \hat{σ}² are then computed by iteratively maximizing the log-likelihood. In the current framework, \hat{μ} is calculated for each node (mRNA and miRNA) of the extended pathways. The estimated overall effect size \hat{μ} and the combined p-value of individual genes and miRNAs serve as input for Impact Analysis.

Combining Independent P-Values

Here is a summary of some classical methods for combining independent p-values. The additive method that is used to combine p-values for each mRNA and miRNA molecule in the current framework is then described.

Fisher's method is the most widely used method for combining independent p-values. Considering a set of m independent significance tests, the resulting p-values P₁, P₂, . . . , Pₘ are independent and uniformly distributed on the interval [0, 1] under the null hypothesis. The random variables Xᵢ=−2InP, (i∈{1, 2, . . . , m}) follow a chi-squared distribution with two degrees of freedom (X₂ₘ²). Consequently, the log product of m independent p-values follows a chi-squared distribution with 2m degrees of freedom. If one of the individual p-values approaches zero, which is often the case for empirical p-values, then the combined p-value approaches zero as well, regardless of other individual p-values. For example, if P₁→0, then X→∞ and therefore, Pr(X)→0 regardless of P₂, P₃, . . . , Pₘ.

Stouffer's method is another classical method that is closely related to Fisher's. The test statistic of Stouffer's method is the sum of p-values transformed into standard normal variables, divided by the square root of m. Denoting ϕ as the standard normal cumulative distribution function, and pᵢ(i∈[1..m]) the individual p-values that are independently and uniformly distributed under the null, the z-scores are calculated as zᵢ=ϕ⁻¹ (1−pᵢ). By definition, these z-scores follow the standard normal distribution. The summary statistic of Stouffer's method

$$( \frac{{\sum }_{i = 1}^{m} {z}_{i}}{\sqrt{m}} )$$

also follows the standard normal distribution under the null hypothesis. Similar to Fisher's method, the combined p-values approach zero when one of the individual p-values approaches zero.

The additive method uses the sum of the p-values as the test statistic, instead of the log product. Consider the p-values resulting from m independent significance tests, P₁, P₂, . . . , Pₘ. Let the sum of these p-values, X=Σᵢ₌₁^{m}Pᵢ (X ∈ [0,m]), be the new random variable. X follows the Irwin-Hall distribution with the following probability density function (pdf):

$$f ( x ) = \frac{1}{( m - 1 ) !} + {\sum }_{i = 0}^{⌊ x ⌋} ( - 1 ) ( \begin{matrix}m \\ i\end{matrix} ) {( x - i )}^{m - 1} \qquad ( 8 )$$

when m is large, some addends will be too small or too large to be stored in the memory. This leads to a totally inaccurate calculation when m passes a certain threshold, depending on the number of bits used to store numbers on the computer. For this reason, a modified version of the additive method, named add-CLT, was proposed.

Let Y represent the average of p-values:

$$Y = \frac{{\sum }_{i = 1}^{m} {P}_{i}}{m} ( Y ∈ [ 0 , 1 ] ) .$$

### Since

$$Y = \frac{x}{m}$$

the probability density function (pdf) and the corresponding cumulative distribution function (cdf) of Y can be derived using a linear transformation of X as follows:

$$g ( y ) = \frac{m}{( m - 1 ) !} + {\sum }_{i = 0}^{⌊ m \cdot y ⌋} {( - 1 )}^{i} ( \begin{matrix}m \\ i\end{matrix} ) {( m \cdot y - i )}^{m - 1} \\ G ( y ) = \frac{1}{m !} + {\sum }_{i = 0}^{⌊ m \cdot y ⌋} {( - 1 )}^{i} ( \begin{matrix}m \\ i\end{matrix} ) {( m \cdot y - i )}^{m} \qquad ( 9 )$$

The variable Y is the mean of m independent and identically distributed (i.i.d.) random variables (the p-values from each individual experiment), that follow a uniform distribution with a mean of ½ and a variance of 1/12. From the Central Limit Theorem, the average of such m i.i.d. variables follows a normal distribution with mean μ=½ and variance

$${σ}^{2} = \frac{1}{12 m} , i . e . , Y \sim N ( \frac{1}{2} , \frac{1}{12 m} )$$

for sufficiently large values of m. The transition from the additive method to the Central Limit Theorem takes place at the m≥20 threshold

Here, the add-CLT method described above is used to combine the p-values calculated from the modified t-test (limma package).

Graphical Representation of Augmented Pathways

A formal description of the pathway augmentation process is provided. Let P=(V, E) be the graphical representation of the pathway to be extended with miRNA-mRNA interactions. V is the set of vertices (genes) while the directed edges in E represent the interactions between genes in the pathway. Each interaction includes an ordered pair of vertices and the type of interaction between the pair, i.e., E={(xᵢ,yᵢ), rᵢ} where xᵢ, yᵢ ∈ G (gene set) and rᵢ is the type of relation between xᵢ and yᵢ, such as activation, repression, phosphorylation, etc. Topology-based pathway analysis methods, such as Impact Analysis, use interaction types to weigh the edges or to set the strength of signal propagation along the paths in a pathway.

From the miRNA database, a set of miRNAs and their targets is provided. Denote Z as the set of known miRNAs, ζ ∈ Z is one miRNA, and t(ζ) is the set of known targets for the miRNA ζ. The augmented pathway of P=(V, E) is denoted as P*=(V*, E*) and is constructed as follows.

V*=V ∪ {ζ ∈ Z:t(ζ) ∩ V ≠ Ø}

E*=E ∪ {(ζ,g,repression): ζ ∈ Z,g ∈ t(ζ) ØV} (10)

In other words, if a miRNA ζ targets a gene g that belongs to the pathway, ζ is added to the pathway and ζ is then connected with its targets in the pathway. By default, the interaction type of new edges is repression, which represents the translation blockage of miRNAs to mRNA. The interaction type can be changed to suit the interaction between the miRNA molecule and its targets. All pathways in the pathway database are extended using the formulation described in Equation (10). The R package mirIntegrator for pathway augmentation is available on Bioconductor website (world wide web.bioconductor.org).

Impact Analysis of Augmented Pathways

The Impact Analysis method combines two types of evidence: (i) the over-representation of DE genes in a given pathway, and (ii) the perturbation of that pathway, caused by disease, as measured by propagating expression changes through the pathway topology. These two aspects are captured, respectively, by the independent probability values, P_{NDE} and P_{PERT}. Impact Analysis formulation is summarized.

The first p-value, P_{NDE}, is obtained using the hypergeometric model, which is the probability of obtaining at least the observed number of differentially expressed genes. The second p-value, P_{PERT}, depends on the identity of the specific genes that are differentially expressed as well as on the interactions described by the pathway. It is calculated based on the perturbation factor in each pathway. The perturbation factor of a gene, PF(g), is calculated as follows.

$$PF ( g ) = Δ E ( g ) + {\sum }_{{μϵ US}_{g}} {β}_{ug} \cdot \frac{PF ( u )}{{N}_{ds} ( u )} \qquad ( 11 )$$

The first term represents the signed normalized expression change of the gene g, i.e., log standardized mean difference as shown in panels (e,f) of FIG. 5. The second term is the sum of perturbation factors of upstream genes, normalized by the number of downstream genes of each such upstream gene. The value of β_{ug} quantifies the strength of interaction between u and g. Here, β_{ug}=1 for activation and β_{ug}=−1 for repression.

The above equation essentially describes the perturbation factor PF for a gene as a linear function of the perturbation factors of all genes in a given pathway. In the stable state of the system, all relationships must hold, so the set of all equations defining the impact factors for all genes form a system of simultaneous equations whose solution will provide the values for the gene perturbation factors PF_{g}. The net perturbation accumulation at the level of each gene, Acc(g), is calculated by subtracting the observed expression change from the perturbation factor.

Acc(g)=PF(g)−ΔE(g) (12)

The total accumulated perturbation in the pathway is then computed as follows.

$$Acc ( {P}_{i} ) = {\sum }_{g ϵ {P}_{i}} Acc ( g ) \qquad ( 13 )$$

The null distribution of Acc(Pᵢ) is built by permutation of expression change. The p-value, P_{PERT}, is then calculated by the probability of having values more extreme than the actually observed Acc(Pᵢ).

To compute P_{NDE} and P_{PERT}, the following input is required: the graphical representation of the pathway, the combined p-value of each node of the graph, and the estimated overall standardized mean difference. In short, the graphical representation of the augmented pathways is provided in Equation (10), the p-value for each node of the augmented pathways is computed using Equation (9), and the expression change, ΔE(g), is estimated by iteratively maximizing the log-likelihood function in Equation (7). These two p-values, P_{NDE} and P_{PERT}, are then combined to get a single p-value that represents how likely the pathway is impacted under the effect of the disease. In one or more embodiments, the processor 170 causes the display 176 to generate a graphical representation of the single p-value. Additionally, the processor 170 causes the display 176 to generate a graphical representation of the impact analysis representing the disease and/or the augmented pathways (see panel (g) of FIG. 5).

### Experimental Results

A total of 1,471 samples from 29 public datasets for two human diseases, colorectal and pancreatic cancer, were analyzed. The datasets were generated in independent laboratories, from different individual tissue samples, and were run on different high-throughput platforms. The diseases were selected based on two criteria: (i) there are many publicly available miRNA and mRNA datasets, and (ii) there is a pathway specific to the disease (target pathway). The colorectal data consists of 7 mRNA and 8 miRNA datasets while the pancreatic data consists of 8 mRNA and 6 miRNA datasets. The processed data sets were downloaded directly from the Gene Expression Omnibus using the GEOquery package. The data were rescaled using a log transformation if they were not already in log scale (base 2). The details of each dataset, such as the number of samples, tissues, and platforms, are reported in Table 1.

TABLE 1
Description of miRNA and mRNA expression datasets used in the
experimental studies. All of the data were downloaded from Gene Expression
Omnibus.

| Cancer | Data | Accession ID | Control | Disease | Tissue | Platform |
|---|---|---|---|---|---|---|
| Colorectal | mRNA | GSE4107 | 10 | 12 | Colonic mucosa | Affymetrix HG U133 Plus 2.0 |
| | | GSE9348 | 12 | 70 | Colonic mucosa | Affymetrix HG U133 Plus 2.0 |
| | | GSE15781 | 10 | 13 | Colon | ABI HG Survey 2 |
| | | GSE21510 | 25 | 123 | Colon | Affymetrix HG U133 Plus 2.0 |
| | | GSE23878 | 24 | 35 | Colon | Affymetrix HG U133 Plus 2.0 |
| | | GSE41657 | 12 | 25 | Colonic mucosa, epithelial | Agilent-014850 HG 4x44K G4112F |
| | | | | | neoplasm | |
| | | GSE62322 | 18 | 20 | Colon | Affymetrix HG U133A |
| | miRNA | GSE33125 | 9 | 9 | Colon | Illumina Human v2 MicroRNA |
| | | GSE35834 | 23 | 55 | Colon & rectum | Affymetrix miRNA 1.0 |
| | | GSE39814 | 9 | 10 | FHC, HCT116, & SW480 cells | Agilent-021827 Human miRNA |
| | | GSE39833 | 11 | 88 | Peripheral blood serum | Agilent-021827 Human miRNA |
| | | GSE41655 | 15 | 33 | Colonic mucosa, & epithelial | Agilent-021827 Human miRNA |
| | | | | | neoplasm | |
| | | GSE49246 | 40 | 40 | Colon | Sun Yat-Sen Human microRNA |
| | | GSE54632 | 5 | 5 | Colonic and rectal mucosa | Affymetrix miRNA 1.0 |
| | | GSE73487 | 23 | 90 | Colon | Affymetrix miRNA 1.0 |
| Pancreatic | mRNA | GSE15471 | 39 | 39 | Pancreas | Affymetrix HG U133 Plus 2.0 |
| | | GSE19279 | 3 | 4 | Pancreas, pancreatic duct | Affymetrix HG U133A |
| | | GSE27890 | 4 | 4 | Pancreas, ductal epithelia | Affymetrix HG U133 Plus 2.0 |
| | | GSE32676 | 7 | 25 | Pancreas | Affymetrix HG U133 Plus 2.0 |
| | | GSE36076 | 10 | 3 | Peripheral blood mononuclear cells | Affymetrix HG U133 Plus 2.0 |
| | | GSE43288 | 3 | 4 | Pancreas | Affymetrix HG U133A |
| | | GSE45757 | 9 | 132 | Pancreatic epithelial & cancer cells | Affymetrix HG U133A |
| | | GSE60601 | 3 | 9 | CD14++ & CD16− cells | Affymetrix HG U133 Plus 2.0 |
| | miRNA | GSE24279 | 22 | 136 | Pancreas | Febit human miRBase v11 |
| | | GSE25820 | 4 | 5 | Pancreatic duct | Agilent-019118 Human miRNA |
| | | GSE32678 | 7 | 25 | Pancreas | miRCURY LNA microRNA, v.11.0 |
| | | GSE34052 | 6 | 6 | Pancreas | Agilent-029297 Human miRNA |
| | | GSE43796 | 5 | 26 | Pancreas | Agilent-031181 Human miRNA V16 |
| | | GSE60978 | 6 | 51 | Pancreatic duct | Agilent-031181 Human miRNA V16 |

The databases used in this analysis are KEGG for pathways, and miRTarBase for miRNAs. 182 signaling pathways are downloaded from KEGG version 76 (Dec. 4, 2015) by means of the R package ROntoTools. These pathways are augmented with known miRNAs and their target interactions, downloaded from miRTarBase. For each mRNA/miRNA, the modified t-test, available in the limma package, is used to test for differential expression of mRNA/miRNAs. add-CLT is used as the method to combine independent p-values. The combined p-values are then adjusted for multiple comparisons using False Discovery Rate (FDR). For expression change, Hedges' g is used as effect size, and the REML method is used to estimate the central tendency of effect sizes. Following convention, only mRNA/miRNAs having FDR-corrected combined p-values less than 5% are taken into consideration. Among these significant genes, mRNA/miRNAs are chosen that have the highest estimated SMD as differentially expressed, up to 10% of total measured mRNA/miRNAs. All the R scripts used for data processing, pathway augmentation, and analysis are available.

For both diseases, the orthogonal approach (ImpactAnalysis_I) is compared with 5 other approaches: pathway-level meta-analysis (ImpactAnalysis_P), gene-level meta-analysis (ImpactAnalysis_G), plus the 3 meta-analysis approaches available in MetaPath package. Because the input data sets include multiple studies, none of which are sample-matched, pathway analysis using approaches that integrate matched mRNA and miRNA expression cannot be performed.

For pathway-level meta-analysis (ImpactAnalysis_P), Impact Analysis is performed on each mRNA expression dataset and then the independent p-values for each pathway are combined. For example, if there are 7 mRNA datasets, there are 7 nominal p-values per pathway—one for each study. These 7 p-values are independent and thus can be combined using the add-CLT method to get one combined p-value. The final result is a list of 182 p-values for 182 signaling pathways. The combined p-values for multiple comparisons are then adjusted using FDR.

For gene-level meta-analysis (ImpactAnalysis_G), the modified t-test for each mRNA dataset were performed and then the p-values were combined. With 7 mRNA datasets, for example, each gene will have 7 independent p-values, which will be combined into one p-value. We also calculate the SMD and standard error of each gene in each study, then use the REML algorithm to calculate the overall effect size across the 7 studies. Finally, pathway analysis is performed on 182 KEGG pathways using the combined p-values and the estimated effect sizes, resulting in a graphical representation, i.e., a list, of pathways ranked according to their p-values. The p-values of pathways for multiple comparisons are adjusted using FDR.

The integrative approach (ImpactAnalysis_I) is similar to ImpactAnalysis_G, with the exception that ImpactAnalysis_I uses both mRNA and miRNA data. The meta-analysis is done on the mRNA/miRNA level and then the combined p-values and estimated effect sizes of mRNA/miRNAs serve as the input to the ImpactAnalysis.

MetaPath is a dedicated approach that performs meta-analysis at both gene (MetaPath_G) and pathway levels (MetaPath_P) with a GSEA-like approach, and then combines the results (MetaPath_I) to give the final p-value and ranking of pathways. MetaPath first calculates the t-statistic for each gene in each study. In MetaPath_G, these statistics are combined for each gene using maxP. The combined statistics are then used to calculate enrichment scores for each pathway using a Kolmogorov-Smirnov test. In MetaPath_P, the pathway enrichment analysis is done first before meta-analysis. In MetaPath_I, the p-values of MetaPath_G and MetaPath_P are combined using minP.

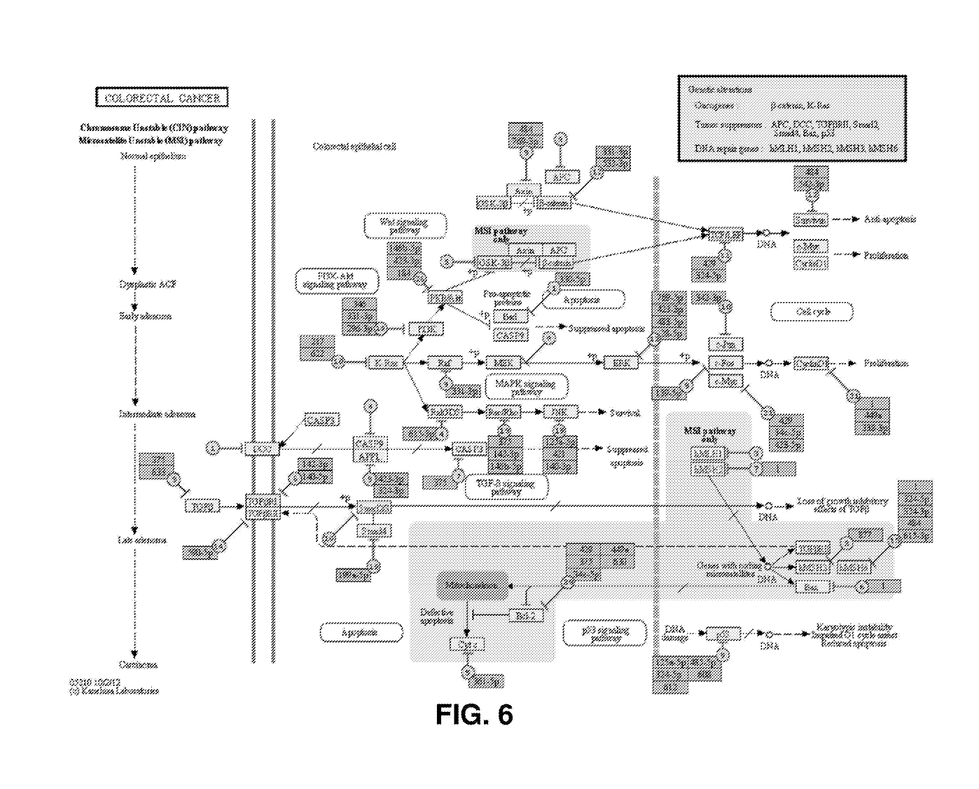

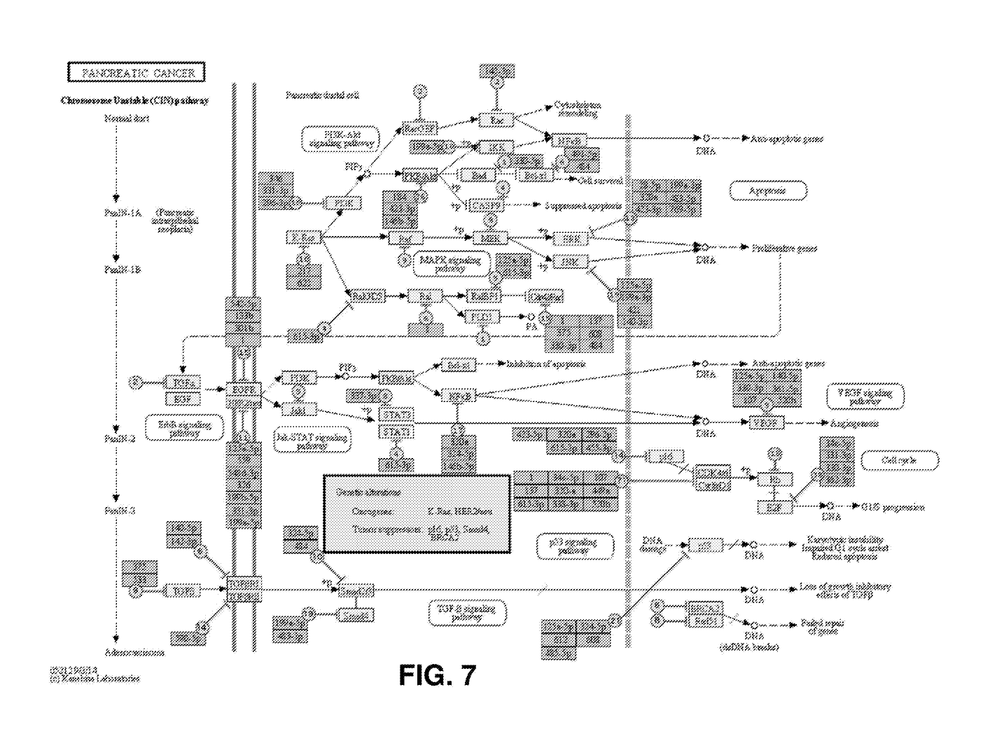

For each of the two diseases, there is a target KEGG pathway, which is the pathway created to describe the main phenomena involved in the respective disease. The augmented pathway for Colorectal cancer is displayed in FIG. 6. The green rectangle nodes (light shaded rectangles) show the KEGG genes and the black arrows show the interactions between the genes. The blue nodes (dark shaded rectangles) and the bar-headed lines show the miRNA molecules and their interactions with the genes, where the bar-headed lines represents the “repression” activity. In each augmented node, two types of information are displayed: i) the total number of miRNAs that are known to target the corresponding gene, and ii) the miRNAs that were actually measured in the 8 miRNA colorectal datasets. The former is displayed in circles while the latter is listed in blue rectangles (dark shaded rectangles). For example, the gene TGFβ (in the far left of the figure) has 9 miRNAs that are known to target the gene but only two miRNAs (hsa:miR-375 and hsa:miR-633) were included in the miRNA data. Similarly, the augmented pathway for Pancreatic cancer is displayed in FIG. 7. The graphs show that both target pathways are heavily regulated by miRNA molecules.

In this experimental study, it is expected that a good pathway analysis approach would be able to identify the very pathway that describes the disease phenomena as the most significant in each particular disease. Hence, the various methods based on this criterion are compared.

Colorectal Cancer

8 miRNA (GSE33125, GSE35834, GSE39814, GSE39833, GSE41655, GSE49246, GSE54632, and GSE73487) and 7 mRNA (GSE4107, GSE9348, GSE15781, GSE21510, GSE23878, GSE41657, and GSE62322datasets are obtained from the Gene Expression Omnibus (GEO), as shown in Table 1.

Table 2 shows the results of the 6 approaches. The horizontal line across each list marks the cutoff FDR=0.01. The pathway highlighted in green is the target pathway Colorectal cancer. MetaPath_P (pathway-level meta-analysis) identifies no significant pathway at the 1% cutoff, and ranks the target pathway at position 16^{th}. Similarly, MetaPath_G (gene-level meta-analysis) and MetaPath_I (combination of gene- and pathway-level) identify no significant pathways. They rank the target pathway at positions 9^{th} and 15^{th}, respectively.

TABLE 2
The 16 top ranked pathways and FDR-corrected p-values obtained by
combining colorectal data using 6 approaches: MetaPath_P, MetaPath_G, MetaPath_I,
ImpactAnalysis_P, ImpactAnalysis_G, and ImpactAnalysis_I. The horizontal lines show
the 1% significance threshold. The target pathway is colorectal cancer. All other
approaches, MetaPath_P, MetaPath_G, MetaPath_I, ImpactAnalysis_P,
ImpactAnalysis_G fail to identify the target pathway as significant, and rank it at the
positions 16th, 9th, 15th, 61st, and 10th, respectively. On the contrary, the integrative
approach, ImpactAnalysis_I, identifies the target pathway as significant and ranks it on
top.

| | MetaPath_P (mRNA, pathway-level) | | MetaPath_G (mRNA, gene-level) | | MetaPath_I (mRNA, both-level) | |
|---|---|---|---|---|---|---|
| | Pathway | p. fdr | Pathway | p. fdr | Pathway | p. fdr |
| 1 | Aldosterone-regulated sodium | 0.0941 | Thyroid cancer | 0.1460 | Thyroid cancer | 0.1460 |
| | reabsoption | | | | | |
| 2 | Peroxisome | 0.2319 | Dorso-ventral axis | 0.1533 | Aldosterone-regulated | 0.1880 |
| | | | formation | | sodium reabsorption | |
| 3 | Pancreatic cancer | 0.2402 | Mineral absorption | 0.1550 | Endocrine and other factor- | 0.2006 |
| | | | | | regulated calcium | |
| | | | | | reabsorption | |
| 4 | Small cell lung cancer | 0.2500 | PPAR signaling pathway | 0.1575 | Mineral absorption | 0.2047 |
| 5 | Endocrine and other factor- | 0.2540 | Ribosome biogenesis in | 0.2376 | PPAR signaling pathway | 0.2065 |
| | regulated calcium reabsorption | | eukaryotes | | | |
| 6 | Epithelial cell signaling in | 0.2630 | Renin-angiotensin system | 0.2609 | Dorso-ventral axis | 0.227 |
| | Helicobacter pylori infection | | | | formation | |
| 7 | Mineral absorption | 0.2727 | Vibrio cholerae infenction | 0.3002 | Small cell lung cancer | 0.2713 |
| 8 | Glioma | 0.3234 | Aldosterone-regulated | 0.3478 | Renin-angiotensin system | 0.2731 |
| | | | sodium reabsorption | | | |
| 9 | Dorso-ventral axis formation | 4.4665 | Colorectal cancer | 0.3514 | Pancreatic cancer | 0.2811 |
| 10 | Epstein-Barr virus infection | 0.4683 | Bile secretion | 0.4286 | Peroxisome | 0.2870 |
| 11 | NOD-like receptor signaling | 0.4772 | Pancreatic secretion | 0.4361 | Ribosome biogensis in | 0.2906 |
| | pathway | | | | eukaryotes | |
| 12 | Legionellosis | 0.4772 | Epithelial cell signaling in | 0.4427 | Vibrio cholerae infection | 0.2918 |
| | | | Helicobacter pylori infection | | | |
| 13 | GmRH signaling pathway | 0.4778 | Intestinal immune netwrok | 0.4519 | Epithelial cell signaling in | 0.2951 |
| | | | for IgA production | | Helicobacter | |
| 14 | Progesterone-mediated oocyte | 0.4946 | Type I diabetes mellitus | 0.4576 | Glioma | 0.3561 |
| | maturation | | | | | |
| 15 | TNF signaling pathway | 0.5135 | Cardiac muscle contraction | 0.4607 | Colorectal cancer | 0.4047 |
| 16 | Colorectal cancer | 0.5178 | Allograft rejection | 0.4616 | NOD-like receptor | 0.4693 |
| | | | | | signaling pathway | |
| | ImpactAnalysis_P (mRNA, pathway-level) | | ImpactAnalysis_G (mRNA, gene-level) | | ImpactAnalysis_I (mRNA, both-level) | |
| | Pathway | p. fdr | Pathway | p. fdr | Pathway | p. fdr |
| 1 | PPAR signaling pathway | <10⁻⁴ | Ribosome biogenesis in | 0.0008 | Colorectal cancer | 0.0002 |
| | | | eukaryotes | | | |
| 2 | Rheumatoid arthritis | <10⁻⁴ | Cell cycle | 0.0008 | Ribosome biogensis in | 0.0002 |
| | | | | | eukaryotes | |
| 3 | Cytokine-cytokine receptor | <10⁻⁴ | Mineral absorption | 0.0185 | PPAR signaling pathway | 0.0002 |
| | interaction | | | | | |
| 4 | Chemokine signaling pathway | <10⁻⁴ | p53 signaling pathway | 0.0292 | Cell cycle | 0.0006 |
| 5 | Bile secretion | <10⁻⁴ | Progesterone-mediated | 0.0347 | Progesterone-mediated | 0.0077 |
| | | | oocyte maturation | | oocyte maturation | |
| 6 | MicroRNAs in cancer | 0.0005 | Oocyte Meiosis | 0.0348 | Oocyte meiosis | 0.0130 |
| 7 | Malaria | 0.0007 | Bile secretion | 0.0364 | TGF-beta signaling pathway | 0.0130 |
| 8 | Mineral absorption | 0.0012 | PPAR signaling pathway | 0.0915 | Parkinson's disease | 0.0130 |
| 9 | Pancreatic secretion | 0.0046 | Small cell lung cancer | 0.1014 | Peroxisome | 0.0139 |
| 10 | ECM-receptor interaction | 0.0047 | Colorectal cancer | 0.1036 | MicroRNAs in cancer | 0.0140 |
| 11 | Insulin secretion | 0.0047 | RNA transport | 0.1059 | Thyroid cancer | 0.0214 |
| 12 | Amoebiasis | 0.0056 | RNA degradation | 0.1720 | RNA transport | 0.0214 |
| 13 | Complement and coagulation | 0.0111 | MicroRNAs in cancer | 0.2051 | AGE-RANGE signaling | 0.0214 |
| | cascades | | | | pathway in diabetic | |
| | | | | | complications | |
| 14 | P13K-Akt signaling pathway | 0.0131 | Peroxisome | 0.2051 | NOD-like receptor | 0.0304 |
| | | | | | signaling pathway | |
| 15 | TNF signaling pathway | 0.0194 | Pathways in cancer | 0.2080 | Endometrial cancer | 0.0309 |
| 16 | Transcriptional misregulation | 0.0267 | Parkinson's disease | 0.3194 | Pancreatic cancer | 0.0309 |
| | in cancer | | | | | |

The ImpactAnalysis_P approach identifies 12 pathways, among which there are many pathways that are related to cancer. However, the target pathway Colorectal cancer is not significant and is ranked 61^{st} with adjusted p=0.99. The gene-level meta-analysis (ImpactAnalysis_G) offers some improvement over ImpactAnalysis_P by improving the ranking (10^{th}) and adjusted p-value (p=0.1) of the target pathway Colorectal cancer. However, the target pathway is still not significant with the given threshold. The orthogonal meta-analysis, ImpactAnalysis_I, is able to further boost the power of the gene-level meta-analysis. It identifies 5 significant pathways, with the target pathway Colorectal cancer ranked at the very top. This is very likely due to the additional information provided by miRNA expression and prior knowledge accumulated in miRTarBase.

Three of the other 4 pathways that are identified by ImpactAnalysis_I appear to be true positives. The Cell Cycle and Ribosome Biogenesis pathways are implicated in the proliferation aspect of cancer tissue. PPAR signaling has a role in colorectal cancer, although it is not fully understood. Progesterone-mediated oocyte maturation is clearly a false positive which may have appeared due to the presence of several cell cycle genes in that pathway.

Pancreatic Cancer

8 mRNA (GSE15471, GSE19279, GSE27890, GSE32676, GSE36076, GSE43288, GSE45757, and GSE60601) and 6 miRNA datasets (GSE24279, GSE25820, GSE32678, GSE34052, GSE43796, and GSE60978) are obtained from Gene Expression Omnibus (GEO), as shown in Table 1. Again, the current approach (ImpactAnalysis_I) is compared with 5 other approaches: pathway-level meta-analysis, gene-level meta-analysis using only mRNA data, plus 3 meta-analysis approaches available in the MetaPath package as shown in Table 3.

TABLE 3
The 10 top ranked pathways and FDR-corrected p-values obtained by
combining colorectal data using 6 approaches: MetaPath_P, MetaPath_G, MetaPath_I,
ImpactAnalysis_P, ImpactAnalysis_G, and ImpactAnalysis_I. The horizontal lines show
the 1% significance threshold. The target pathway is pancreatic cancer. All other
approaches, MetaPath_P, MetaPath_G, MetaPath_I, ImpactAnalysis_P,
ImpactAnalysis_G fail to identify the target pathway as significant, and rank it at the
positions 17^{th}, 91^{st}, 91^{st}, 32^{nd}, and 8^{th}, respectively. On the contrary, the integrative
approach, ImpactAnalysis_I, identifies the target pathway as significant and ranks it on
top.

| | MetaPath_P (mRNA, pathway-level) | | MetaPath_G (mRNA, gene-level) | | MetaPath_I (mRNA, both-level) | |
|---|---|---|---|---|---|---|
| | Pathway | p. fdr | Pathway | p. fdr | Pathway | p. fdr |
| 1 | Graft-versus-host-disease | 0.4782 | Autoimmune thyroid disease | 0.0020 | Type I diabetes mellitus | 0.0040 |
| 2 | Small cell lung cancer | 0.5440 | Allograft rejection | 0.0020 | Autoimmune thyroid disease | 0.0040 |
| 3 | SNARE interactions in vesicular | 0.553 | Type I diabetes mellitus | 0.003 | Allograft rejection | 0.004 |
| | transport | | | | | |
| 4 | Leishmaniasis | 0.6404 | Graft-versus-host disease | 0.0040 | Graft-versus-host-disease | 0.0080 |
| 5 | Bladder cancer | 0.7010 | GABAergic synapse | 0.0050 | GABAergic synapse | 0.0100 |
| 6 | MicroRNAs in cancer | 0.7244 | Asthma | 0.0073 | Asthma | 0.0147 |
| 7 | Phagosome | 0.7330 | Morphine addiction | 0.0074 | Morphine addiction | 0.0149 |
| 8 | Type I diabetes mellitus | 0.7515 | ECM-receptor interaction | 0.0104 | ECM-receptor interaction | 0.0208 |
| 9 | Pertussis | 0.7682 | Maturity onset diabetes of the | 0.0139 | Maturity onset diabetes of the | 0.0278 |
| | | | young | | young | |
| 10 | Dorso-ventral axis formation | 0.7941 | Renin-angiotensin system | 0.0153 | Renin-angiotensin system | 0.0307 |
| | ImpactAnalysis_P (mRNA, pathway-level) | | ImpactAnalysis_G (mRNA, gene-level) | | ImpactAnalysis_I (mRNA + miRNA) | |
| | Pathway | p. fdr | Pathway | p. fdr | Pathway | p. fdr |
| 1 | PI3K-Akt signaling pathway | 0.0019 | Small cell lung cancer | 0.0217 | Pancreatic cancer | 0.0017 |
| 2 | MicroRNAS in cancer | 0.0076 | Pathways in cancer | 0.0217 | Small cell lung cancer | 0.0017 |
| 3 | Small cell lung cancer | 0.0276 | Viral carcinogenesis | 0.0217 | Pathways in cancer | 0.0017 |
| 4 | Pathways in cancer | 0.0962 | ECM-receptor interaction | 0.0480 | Proteoglycans in cancer | 0.0017 |
| 5 | TNF signaling pathway | 0.1106 | Hepatitis B | 0.0480 | Amoebiasis | 0.0031 |
| 6 | PPAR signaling pathway | 0.1216 | HRLV-I infection | 0.0623 | AGE-RANGE signaling pathway in | 0.0040 |
| | | | | | diabetic complications | |
| 7 | NF-kappa B signaling pathway | 0.1502 | Chronic myeloid leukemia | 0.0623 | Focal adhesion | 0.0040 |
| 8 | Shigellosis | 0.2491 | Pancreatic cancer | 0.0623 | HTLV-I infection | 0.0119 |
| 9 | Chemokine signaling pathway | 0.2742 | Amoebiasis | 0.0639 | Chronic myeloid leukemia | 0.0125 |
| 10 | T cell receptor signaling pathway | 0.3200 | Pathogenic Escherichia coli | 0.0639 | ECM-receptor interaction | 0.0142 |
| | | | infection | | | |

MetaPath_P identifies no significant pathway and Graft-versus-host disease is ranked on top with adjusted p-value 0.4782. The target pathway Pancreatic cancer is ranked 17^{th} with adjusted p=0.89. MetaPath_G identifies 7 significant pathways. The target pathway is not significant (adjusted p=0.22) and is ranked 91^{st}. In consequence, the combination of these two methods, MetaPath_I, also fails to identify the target pathway as significant (adjusted p=0.34 with ranking 91^{st}).

The pathway-level meta-analysis (ImpactAnalysis_P) identifies the PI3K-Akt signaling pathway and MicroRNAs in cancer as significant. The significance of MicroRNAs in cancer may indicate the importance of miRNA in pancreatic cancer, and PI3K-Akt signaling alteration is known to be involved in many cancers. However, the target pathway is not significant (adjusted p=0.95 with ranking 32^{nd}). The gene-level meta-analysis (ImpactAnalysis_G) improves the ranking of the target pathway (8^{th}) but the p-value of the target pathway is still not significant. The orthogonal approach, ImpactAnalysis_I, identifies 7 pathways as significant. The target pathway Pancreatic cancer is ranked on top with FDR-corrected p-value 0.0017.

Of the 6 significant non-target pathways found by ImpactAnalysis_I, three are cancer-related by name (Small cell lung cancer, Pathways in cancer, Proteoglycans in cancer). The breakdown of cell matrix adhesions, such as Focal Adhesion is an important property of metastasis—most pancreatic cancers are discovered when they are already high grade.

In contrast to the 3 variations of the existing method, MetaPath, the proposed method ImpactAnalysis_I was able to effectively combine both independent datasets, as well as the two different types of data (mRNA and miRNA), and correctly report the target pathway as the most significantly impacted pathway in both meta-analysis studies. The results demonstrate that the correct pathways are identified only when the data are integrated both horizontally (combining multiple studies using the same data type) and vertically (combining miRNA with mRNA expression). This orthogonal meta-analysis uses three different kinds of data integration: integration of mRNA and miRNA, combining p-values and combining SMDs for genes and miRNA molecules.

Time Complexity

The data analysis was done on a personal MacBook Pro that has 8 GB 1600 MHz DDR3 RAM, 2.9 GHz Intel Core i7. Because MetaPath cannot exploit multiple processors, all the analysis were run using a single core. The time needed to run MetaPath was 39 minutes for Colorectal cancer and 47 minutes for Pancreatic cancer.

For ImpactAnalysis_I, the p-value for each gene/miRNA in each dataset is first calculated using the limma package. The p-values are then combined to get one combined p-value per gene/miRNA. Next, the standardized mean difference (SMD) is calculated for each dataset and then the REML algorithm is applied to estimate to overall SMD, using the metafor package. The estimated SMDs and the combined p-values are processed by ROntoTools to produce the p-value for each pathway. ImpactAnalysis_I performs the analysis using the pathways augmented with the relevant miRNAs. The running time for ImpactAnalysis_I is 4 minutes for each of Colorectal and Pancreatic. The running time of each approach is reported in Table 4.

TABLE 4
Running time of each pathway analysis in minutes (m).

| Method | Input | Colorectal | Pancreatic |
|---|---|---|---|
| ImpactAnalysis_I | mRNA & miRNA | 4 m | 4 m |
| MetaPath | mRNA | 39 m | 47 m |

### Discussion

One straightforward horizontal integration is to combine individual p-values provided by each study. In this way, any pathway analysis approach (such as GSEA or GSA) can be applied to the collected mRNA datasets in order to calculate a p-value for each pathway in each study, and then combine these independent p-values. An advantage of this approach is its flexibility. MetaPath combines p-values in this way, but with the slight difference that the p-values are combined on both gene and pathway levels. The drawback is that each of these methods is designed to work with one single matrix of expression values, i.e., one data type. This matrix can be forcefully extended to include other data types as well, but in order to do this, the data must be sample-matched. In other words, all types of assays must be performed on every single sample. In addition, because different data types are assayed on different platforms, the data need to be normalized together, for these approaches to function properly. However, the correct way to do such a cross-platform normalization is still an open problem. The same limitations apply to analysis tools dedicated to miRNA and mRNA integration. For meta-analysis, these approaches would require multiple sets of sample-matched data. Performing different assays on one set of samples is already expensive; asking for many sets of matched samples for the same disease is even more impractical.

Although primarily designed to overcome the matched-sample bottleneck discussed above, the current framework also aims to address a well-known limitation of p-value-based meta-analyses. Classical approaches often rely on hypothesis testing to identify differential expression. This results in critical information loss. While the p-value is partly a function of effect size, it is also partly a function of sample size. For example, with large sample size, a statistical test will tend to find differences as significant, unless the effect size is exactly zero. In reality, any individual study will include some degree of batch effects, such as sampling/study bias, noise, and measurement errors. Simply combining individual p-values would not correct such problems. On the contrary, meta-analysis of effect sizes across all studies would definitely compensate for and eliminate such random effects. This point is illustrated in the results included herein, in particular in the difference between ImpactAnalysis_P and ImpactAnalysis_G for both colorectal and pancreatic cancer (Tables 2 and 3). The former simply combines the p-values, while the latter takes into consideration both p-values and effect sizes across different studies. ImpactAnalysis_G offers a great improvement over ImpactAnalysis_P using the same sets of mRNA data.

The current framework contemplates the computational complexity at both gene and pathway levels. For individual genes and miRNA molecules, the framework not only calculates p-values, but also iteratively estimates the effect sizes and variances. In principle, the iterative algorithm requires more computation than meta-analyses that use closed-form expressions. At pathway-level, Impact Analysis is a non-parametric approach that constructs an empirical distribution of all measured values for each pathway. This requires more computation and storage than parametric approaches, such as the hypergeometric test or Fisher's exact test. However, this is mitigated by the power of modern computers which are able to perform all needed computations in less than 10 minutes, even for datasets with more than 1,000 samples (Table 4). In addition, the current framework allows for parallel computing at the gene-level to reduce the time complexity. However, the time values described here (see, for example, Table 4) do not take advantage of the ability to parallelize the computation in order to be comparable with the results obtained with MetaPath. All values reported in this table are obtained on a single core for both approaches.

The biological results presented here could be further validated by investigating the other pathways reported as significant, and identifying the putative mechanisms that could explain all measured changes. A tool such as iPathway-Guide, could be used to provide more in depth functional analysis, including identification of drugs that are known to act on the observed signaling cascades. Follow-up experiments in which tumor cell lines, or samples from xenografts, are treated with those drugs would validate (or not) both the putative mechanisms investigated, as well as the other significant pathways. If many or all significant pathways were mechanistically implicated in the respective conditions, the proposed orthogonal meta-analysis approach would be further validated.

Another direct application of the orthogonal framework is to infer condition-specific miRNA activity. The proposed gene-level meta-analysis basically identifies genes and miRNAs that are differentially expressed (DE) under the studied condition. This list of DE genes/miRNAs is obtained from a large number of studies and therefore it is expected to be more reliable than any individual study taken alone. From the list of DE genes/miRNAs and the computed statistics (effect sizes and variances), new putative targets of miRNAs can be identified using casual inference techniques. The predicted interactions between miRNA and mRNA can be further verified by established gene-specific experimental validation, such as qRT-PCR, luciferase reporter assays, and western blot.

### Summary

A two-dimensional data integration that is able to combine mRNA and miRNA expression data obtained from many independent experiments is provided herein. The framework first augments pathway knowledge available in pathway databases with miRNA-mRNA interactions from miRNA knowledge bases. It then computes the statistics that are essential for pathway analysis, i.e., the standardized mean difference (SMD) and p-value for differential expression. For each entity, these p-values and the SMDs are computed by combining multiple studies using robust horizontal meta-analysis techniques. Finally, the framework performs a topology-based pathway analysis to identify pathways that are likely to be impacted under the given condition.

To evaluate the framework, 1,471 samples from 15 mRNA and 14 miRNA expression datasets related to two human cancers were examined using 6 different meta-analysis approaches (3 MetaPath approaches and 3 meta-analysis approaches that utilize Impact Analysis). It was demonstrated that the correct pathways are identified only when the data are integrated both horizontally (combining multiple studies using the same data type) and vertically (combining miRNA with mRNA expression).

This technology serves as a bridge between the two orthogonal types of data integration. The result is to unblock the sample-matched data bottleneck, by successfully integrating mRNA and miRNA datasets measured from independent laboratories for different sets of patients. Furthermore, it increases the power of statistical approaches because it allows many studies to be analyzed together. With vast databases of various data types being made available, this framework is widely applicable because of its relaxed restrictions on the data being integrated. The framework is flexible enough to integrate data types other than mRNA and miRNA, which was described herein as an example. It can also be modified to suit other purposes besides pathway analysis.

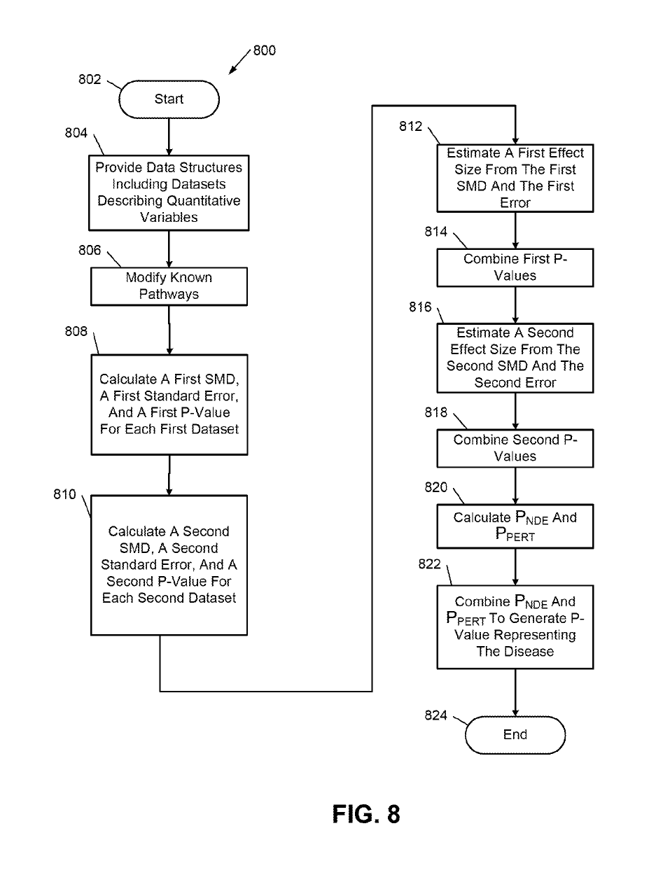

FIG. 8 illustrates an example method 800 for identifying a pathway associated with a disease in accordance with an example embodiment of the present disclosure. Method 800 begins at 802. At 804, multiple data structures, such as databases 202, 204 that provide a first dataset describing a first quantitative variable related to the disease and a second dataset describing a second quantitative variable related to the disease is provided.

At 806, known pathways are modified that are related to the disease with information provided in both the first datasets and the second datasets to generate augmented pathways including a plurality of first nodes associated with the first quantitative variable and a plurality of second nodes associated with the second quantitative variable. At 808, a first standardized mean difference (SMD), a first standard error, and a first p-value for each of the first datasets is calculated.

At 810, a second standardized mean difference (SMD), a second standard error, and a second p-value for each of the second datasets is calculated. At 812, a first effect size from the first SMD and the first standard error is estimated. At 814, the first p-values are combined. At 816, a second effect size from the second SMD and the second standard error is estimated. At 818, the second p-values are combined.

At 820, a probability of obtaining an observed relationship between the first and second quantitative variables associated with the disease (P_{NDE}) and a p-value that depends on identities of first or second quantitative variables that are differentially related and described by the pathway (P_{PERT}) from the augmented pathways, the estimated first effect size, the combined first p-values, the estimated second effect size, and the combined second p-values. At 822, the P_{NDE} and the P_{PERT} are combined to generate a single p-value that represents how likely a pathway is impacted under the effect of the disease. At 824, the method 800 ends.

### Conclusion

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

1. (canceled)

2. (canceled)

3. A method of identifying a pathway associated with a disease, the method comprising:
obtaining, via a processor, a plurality of first datasets describing a first quantitative variable related to the disease and a plurality of second datasets describing a second quantitative variable related to the disease, the plurality of first datasets and the plurality of second datasets being provided from independent studies, wherein each of the plurality of first datasets and each of the plurality of second datasets comprises data regarding disease samples and healthy control samples;
modifying, via the processor, known pathways related to the disease with information provided in both the plurality of first datasets and the plurality of second datasets to generate augmented pathways comprising a plurality of first nodes associated with the first quantitative variable and a plurality of second nodes associated with the second quantitative variable, wherein the first nodes and second nodes are individually interconnected;
calculating, via the processor, a first standardized mean difference (SMD), a first standard error, and a first p-value for each of the plurality of first datasets;
calculating, via the processor, a second SMD, a second standard error, and a second p-value for each of the plurality of second datasets;
estimating, via the processor, a first effect size from the first SMD and the first standard error;
combining, via the processor, the first p-values;
estimating, via the processor, a second effect size from the second SMD and the second standard error;
combining, via the processor, the second p-values;
calculating, via the processor, a probability of obtaining at least an observed relationship between the first and second quantitative variables associated with the disease (P_{NDE}) and a p-value that depends on identities of first or second quantitative variables that are differentially related and described by the pathway (P_{PERT}) from the augmented pathways, the estimated first effect size, the combined first p-values, the estimated second effect size, and the combined second p-values; and
combining, via the processor, P_{NDE} and P_{PERT} to generate a single p-value that represents how likely a pathway is impacted under the effect of the disease.

4. The method according to claim 3, wherein the estimating a first effect size and the estimating a second effect size are performed by using a Restricted Maximum Likelihood (REML) algorithm.

5. The method according to claim 3, wherein the combining the first p-values and the combining the second p-values is performed by add-CLT.

6. The method according to claim 3, wherein the first quantitative variable and the second quantitative variable individually comprise one of molecular data and clinical data.

7. The method according to claim 6, wherein:
the molecular data describes assay results related to at least one of mRNA, miRNA, protein abundance, metabolite abundance, and methylation; and
the clinical data describes patient information related to at least one of weight, blood pressure, blood metabolite level, blood sugar, heart rate, vision score, and hearing score.

8. The method according to claim 3, further comprising:
generating a plurality of single p-values corresponding to a plurality of pathways and generating a graphical representation of the pathways ranked according to their corresponding single p-values.

9. An apparatus for identifying a pathway associated with a disease, the apparatus comprising:
a memory configured to store one or more applications;
a processor communicatively coupled to memory, the processor, upon executing the one or more applications, is configured to:
obtain a plurality of first datasets describing a first quantitative variable related to the disease and a plurality of second datasets describing a second quantitative variable related to the disease, the plurality of first datasets and the plurality of second datasets being provided from independent studies, wherein each of the plurality of first datasets and each of the plurality of second datasets comprises data regarding disease samples and healthy control samples;
modify known pathways related to the disease with information provided in both the plurality of first datasets and the plurality of second datasets to generate augmented pathways comprising a plurality of first nodes associated with the first quantitative variable and a plurality of second nodes associated with the second quantitative variable, wherein the first nodes and second nodes are individually interconnected;
calculate a first standardized mean difference (SMD), a first standard error, and a first p-value for each of the plurality of first datasets;
calculate a second SMD, a second standard error, and a second p-value for each of the plurality of second datasets;
estimate a first effect size from the first SMD and the first standard error;
combine the first p-values;
estimate a second effect size from the second SMD and the second standard error;
combine the second p-values;
calculate a probability of obtaining at least an observed relationship between the first and second quantitative variables associated with the disease (P_{NDE}) and a p-value that depends on identities of first or second quantitative variables that are differentially related and described by the pathway (P_{PERT}) from the augmented pathways, the estimated first effect size, the combined first p-values, the estimated second effect size, and the combined second p-values; and
combine P_{NDE} and P_{PERT} to generate a single p-value that represents how likely a pathway is impacted under the effect of the disease.

10. The apparatus according to claim 9, wherein the processor is configured to estimate a first effect size and estimate a second effect size using a Restricted Maximum Likelihood (REML) algorithm.

11. The apparatus according to claim 9, wherein the processor is configured to combine the first p-values and to combine the second p-values by add-CLT.

12. The apparatus according to claim 9, wherein the first quantitative variable and the second quantitative variable individually comprise one of molecular data and clinical data.

13. The apparatus according to claim 12, wherein:
the molecular data describes assay results related to at least one of mRNA, miRNA, protein abundance, metabolite abundance, and methylation; and
the clinical data describes patient information related to at least one of weight, blood pressure, blood metabolite level, blood sugar, heart rate, vision score, and hearing score

14. The apparatus according to claim 9, wherein the processor is configured to generate a plurality of single p-values corresponding to a plurality of pathways and generate a graphical representation of the pathways ranked according to their corresponding single p-values.

15. The apparatus according to claim 14, wherein the processor is further configured to cause the graphical representation to be displayed at a display.

16. A distributed computing system for identifying a pathway associated with a disease, the distributed computing system comprising:
a first server configured to store a plurality of first datasets;
a second server configured to store a plurality of second datasets, the second server different from the first server;
a third server communicatively coupled to the first server and the second server via a distributed communication network, the third server comprising:
a memory configured to store one or more applications;
a processor communicatively coupled to the memory, the processor, upon executing the one or more applications, is configured to:
obtain the plurality of first datasets describing a first quantitative variable related to the disease and the plurality of second datasets describing a second quantitative variable related to the disease, the plurality of first datasets and the plurality of second datasets being provided from independent studies, wherein each of the plurality of first datasets and each of the plurality of second datasets comprises data regarding disease samples and healthy control samples;
modify known pathways related to the disease with information provided in both the plurality of first datasets and the plurality of second datasets to generate augmented pathways comprising a plurality of first nodes associated with the first quantitative variable and a plurality of second nodes associated with the second quantitative variable, wherein the first nodes and second nodes are individually interconnected;
calculate a first standardized mean difference (SMD), a first standard error, and a first p-value for each of the plurality of first datasets;
calculate a second SMD, a second standard error, and a second p-value for each of the plurality of second datasets;
estimate a first effect size from the first SMD and the first standard error;
combine the first p-values;
estimate a second effect size from the second SMD and the second standard error;
combine the second p-values;
calculate a probability of obtaining at least an observed relationship between the first and second quantitative variables associated with the disease (P_{NDE}) and a p-value that depends on identities of first or second quantitative variables that are differentially related and described by the pathway (P_{PERT}) from the augmented pathways, the estimated first effect size, the combined first p-values, the estimated second effect size, and the combined second p-values; and
combine P_{NDE} and P_{PERT} to generate a single p-value that represents how likely a pathway is impacted under the effect of the disease.

17. The distributed computing system according to claim 16, wherein the processor is configured to estimate a first effect size and estimate a second effect size using a Restricted Maximum Likelihood (REML) algorithm.

18. The distributed computing system according to claim 16, wherein the processor is configured to combine the first p-values and to combine the second p-values by add-CLT.

19. The distributed computing system according to claim 16, wherein the first quantitative variable and the second quantitative variable individually comprise one of molecular data and clinical data.

20. The distributed computing system according to claim 19, wherein:
the molecular data describes assay results related to at least one of mRNA, miRNA, protein abundance, metabolite abundance, and methylation; and
the clinical data describes patient information related to at least one of weight, blood pressure, blood metabolite level, blood sugar, heart rate, vision score, and hearing score.

21. The distributed computing system according to claim 16, wherein the processor is configured to generate a plurality of single p-values corresponding to a plurality of pathways and generate a graphical representation of the pathways ranked according to their corresponding single p-values.

22. The distributed computing system according to claim 21, further comprising a display, wherein the processor is further configured to cause display of the graphical representation at the display.
